(19) United States
(12) Patent Application Publication
(10) Pub. No.: US 2024/0205912 A1
(43) Pub. Date: Jun. 20, 2024

(54) SIDELINK FEEDBACK FOR NETWORK ENERGY SAVINGS

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US); Ahmed Attia ABOTABL, San Diego, CA (US); Krishna Kiran MUKKAVILLI, San Diego, CA (US)

(21) Appl. No.: 18/068,754

(22) Filed: Dec. 20, 2022

(51) Int. Cl. H04W 72/1263; H04W 72/40

(52) U.S. Cl. CPC H04W 72/1263; H04W 72/40

(57) ABSTRACT

Various aspects of the present disclosure generally relate to wireless communication. In some aspects, a wireless communication device may receive information indicating an energy state of a network entity. The wireless communication device may transmit, to the network entity and based at least in part on a transmission configuration, a scheduling request for a sidelink, or feedback regarding a communication on the sidelink, wherein the transmission configuration is based at least in part on the energy state of the network entity. Numerous other aspects are described.

### FIELD OF THE DISCLOSURE

Aspects of the present disclosure generally relate to wireless communication and to techniques and apparatuses for sidelink feedback for network energy savings.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

One aspect provides a method for wireless communication by a wireless communication device. The method includes receiving information indicating an energy state of a network entity; and transmitting, to the network entity and based at least in part on a transmission configuration, a scheduling request for a sidelink, or feedback regarding a communication on the sidelink, wherein the transmission configuration is based at least in part on the energy state of the network entity.

Other aspects provide: an apparatus operable, configured, or otherwise adapted to perform any one or more of the aforementioned methods and/or those described herein with reference to and as illustrated by the drawings; a non-transitory, computer-readable medium comprising computer-executable instructions that, when executed by a processor of an apparatus, cause the apparatus to perform the aforementioned methods and/or those described herein with reference to and as illustrated by the drawings; a computer program product embodied on a computer-readable storage medium comprising code for performing the aforementioned methods and/or those described herein with reference to and as illustrated by the drawings; and/or an apparatus comprising means for performing the aforementioned methods and/or those described herein with reference to and as illustrated by the drawings. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station (BS) and user equipment (UE), in accordance with the present disclosure.

FIG. 3 depicts an example disaggregated base station architecture, in accordance with the present disclosure.

FIGS. 4A, 4B, 4C, and 4D depict aspects of data structures for a wireless communications network, in accordance with the present disclosure.

FIG. 5 is a diagram illustrating an example of sidelink communications, in accordance with the present disclosure.

FIG. 6 is a diagram illustrating an example of sidelink communications and access link communications, in accordance with the present disclosure.

FIG. 7 is a diagram illustrating an example of network operations to reduce energy consumption in accordance with the present disclosure.

FIG. 8 is a diagram illustrating an example of a network entity, a wireless communication device, and a sidelink UE, in accordance with the present disclosure.

FIG. 9 shows a method for wireless communications by a wireless communication device, such as UE or a programmable logic controller (PLC), in accordance with the present disclosure.

FIG. 10 is a diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for sidelink feedback for network energy savings.

UEs can communicate with another on the sidelink. A sidelink is a device-to-device link facilitating communication between UEs. In some deployments, UEs communicating on the sidelink may use resources allocated by a network entity, such as a base station. In some deployments, UEs communicating on the sidelink may be managed by a controller such as a programmable logic controller. Sidelink communication may involve various forms of communication with the network entity, such as transmission of a scheduling request (SR), transmission of a buffer status report (BSR), or transmission of feedback (which may include hybrid automatic repeat request (HARQ) feedback regarding whether a communication is received and/or channel state information (CSI) feedback regarding the sidelink).

A network entity and/or a PLC can use a network energy savings (NES) state, which may specify how certain hardware or operations of the network entity is configured in order to achieve network energy savings. In some examples, a NES state may lead to reduced reception performance (e.g., as characterized by a signal to interference plus noise ratio (SINR)) due to reduced beamforming gain that results from a reduced number of active receive antennas. As another example, a network entity in a particular NES state may not process feedback received in the particular NES state, or may have a reduced reception capability (for example, due to using a decreased number of RF chains or receive antennas), which may lead to a reduction in the number of UEs from which the network entity can effectively and/or concurrently receive feedback or SRs. If transmission of feedback and/or SRs from a wireless communication device or a sidelink UE is performed without concern for the energy state of the network entity, then SRs or feedback may be dropped, leading to diminished throughput, suboptimal utilization of the channel, and increased overhead.

Some techniques described herein provide transmission of feedback (e.g., HARQ feedback or CSI feedback), or an SR, to a network entity based at least in part on an energy state (e.g., a NES state) of the network entity. For example, the network entity may provide an indication of the energy state of the network entity. In some aspects, the SR may use a transmission configuration based at least in part on the energy state. In some aspects, the feedback may use a transmission configuration based at least in part on the energy state. Examples of the impact of the transmission configuration on then SR or the feedback are provided below.

In this way, the transmission of the SR or feedback may take into account the energy state (e.g., NES state) of the network entity, which reduces the occurrence of dropped or missed feedback or SRs, thereby increasing throughput, improving utilization of the channel, and reducing overhead.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

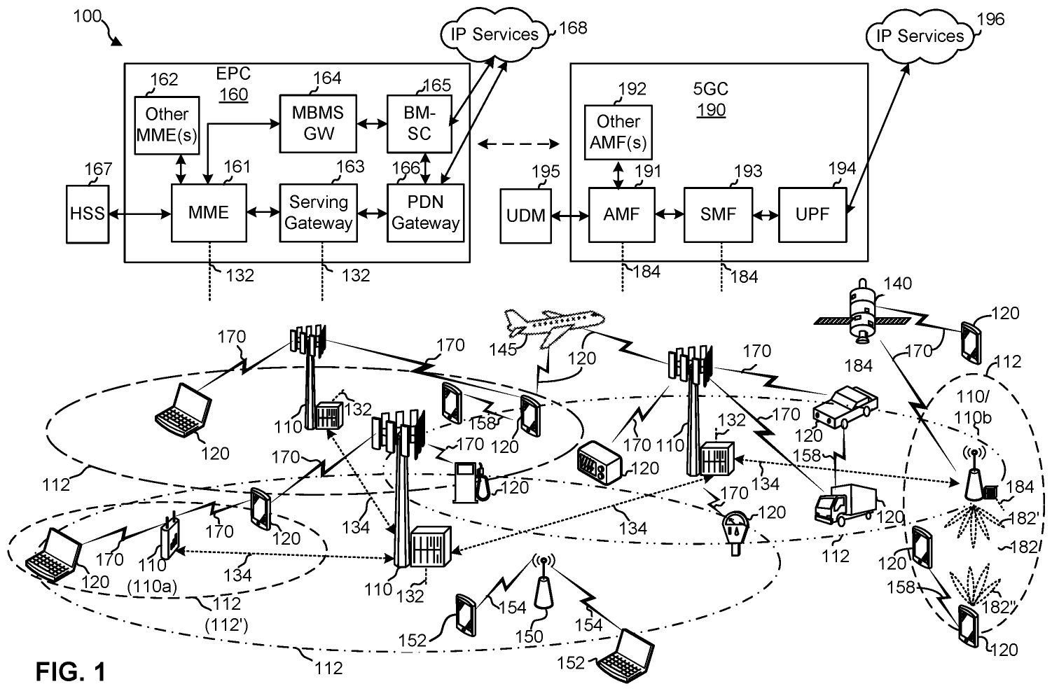

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IoT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point (AP), a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

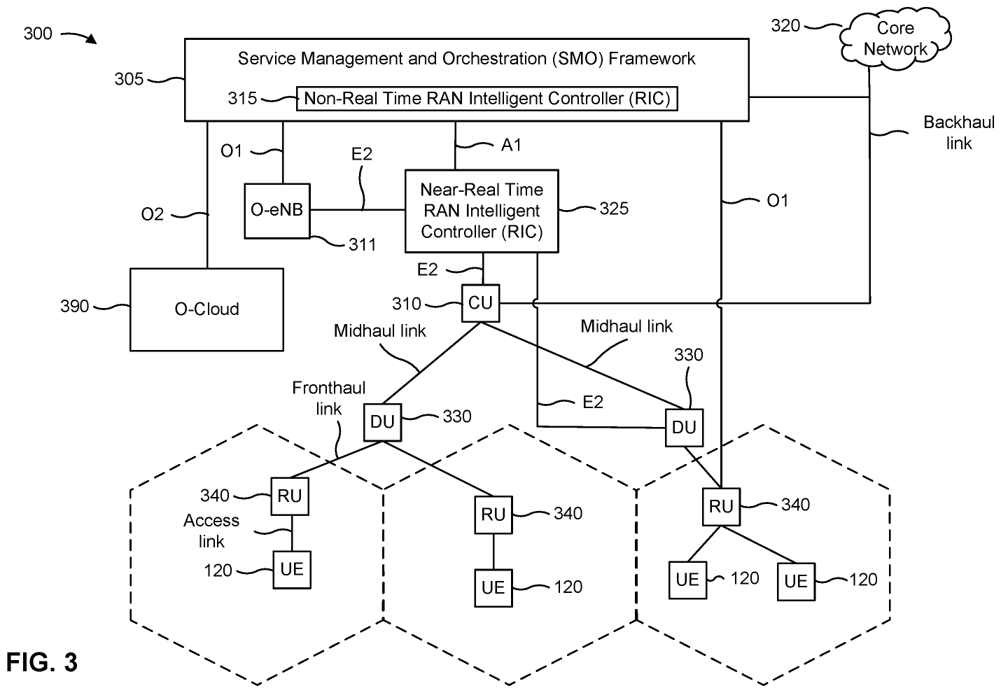

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open RAN (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mm Wave or near mmWave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHZ, 20 MHz, 100 MHz, 400 MHZ, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QOS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

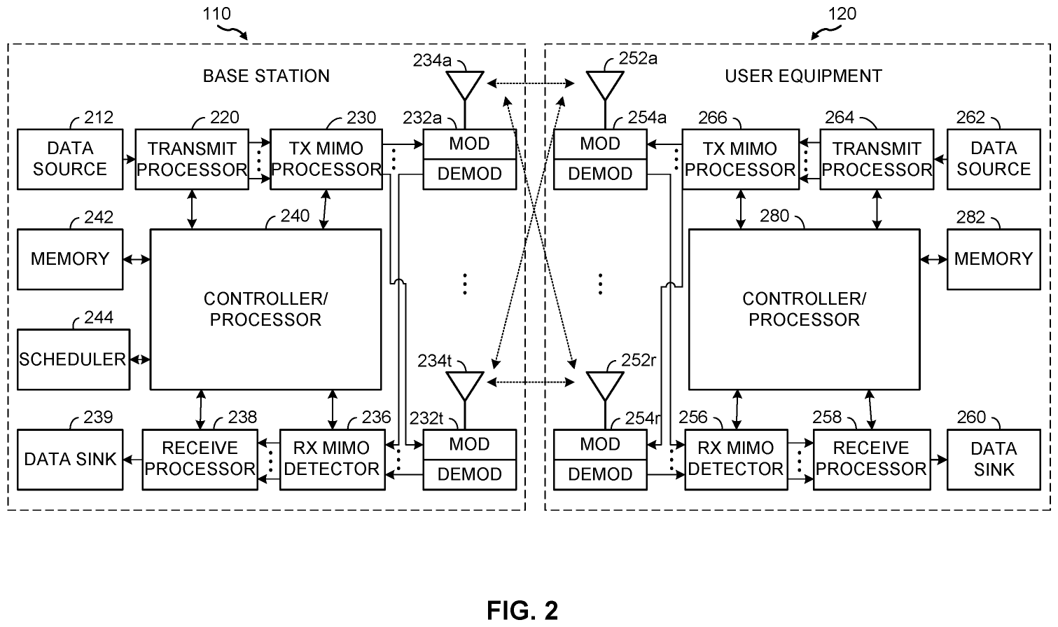

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical HARQ indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the CSI reference signal (CSI-RS).

Transmit (TX) MIMO processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an AP, a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

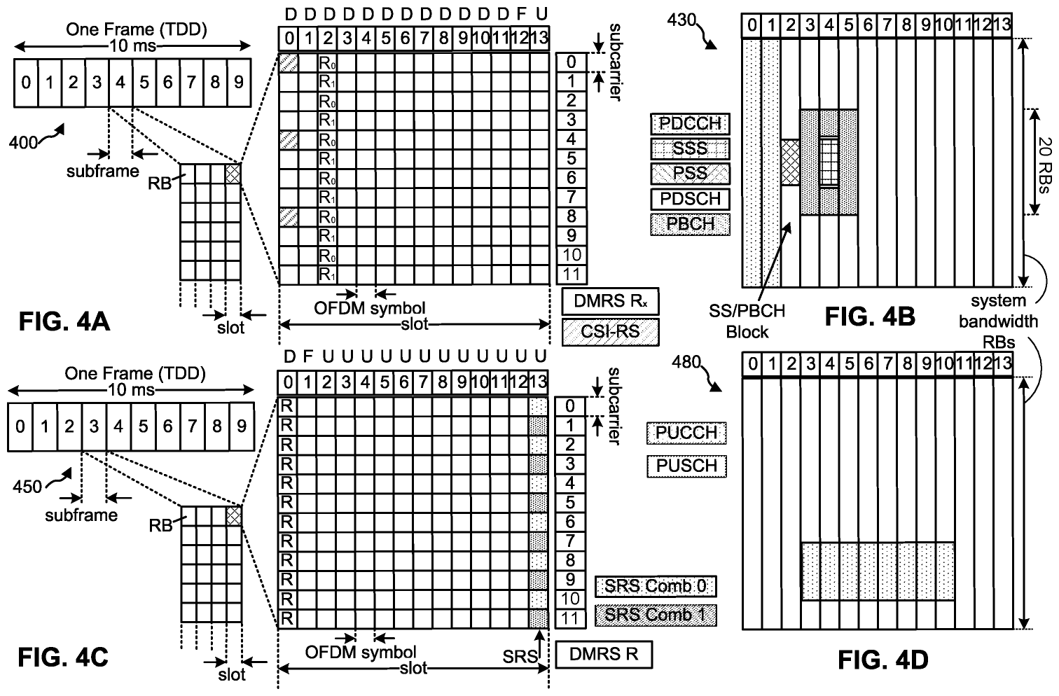

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIGS. 4A and 4C, the wireless communications frame structure is TDD where Dis DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 millisecond (ms) frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (u) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2^{μ} slots/subframe. The subcarrier spacing and symbol length/duration are a function of the numerology. The subcarrier spacing may be equal to 2^{μ}×15 kHz, where u is the numerology index, which may be selected from values 0 to 5. Accordingly, the numerology μ=0 has a subcarrier spacing of 15 kHz and the numerology u=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120). The RSs may include DMRSs and/or CSI-RSs for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The PDCCH carries DCI within one or more control channel elements (CCEs), each CCE including, for example, nine RE groups (REGs), each REG including, for example, four consecutive REs in an OFDM symbol.

A PSS may be within symbol 2 of particular subframes of a frame. The PSS is used by a UE (e.g., UE 120) to determine subframe/symbol timing and a physical layer identity.

An SSS may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The PBCH, which carries a master information block (MIB), may be logically grouped with the PSS and SSS to form a synchronization signal (SS)/PBCH block (SSB). The MIB provides a number of RBs in the system bandwidth and a system frame number (SFN). The PDSCH carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit SRSs. The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a BSR, a power headroom report (PHR), and/or UCI.

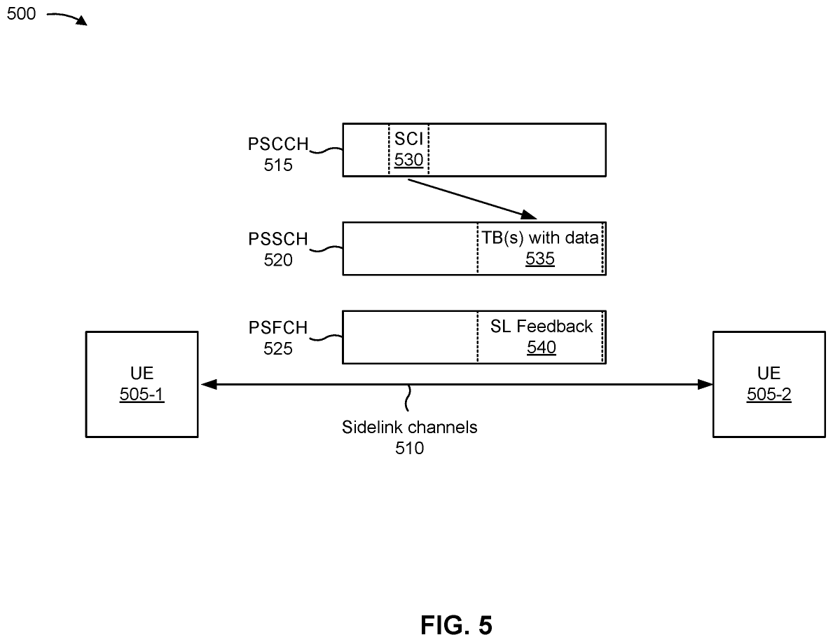

FIG. 5 is a diagram illustrating an example 500 of sidelink communications, in accordance with the present disclosure.

As shown in FIG. 5, a first UE 505-1 may communicate with a second UE 505-2 (and one or more other UEs 505) via one or more sidelink channels 510. The UEs 505-1 and 505-2 may communicate using the one or more sidelink channels 510 for peer-to-peer (P2P) communications, device-to-device (D2D) communications, vehicle-to-anything (V2X) communications (e.g., which may include vehicle-to-vehicle (V2V) communications, V2I communications, and/or V2P communications) and/or mesh networking. In some aspects, the UEs 505 (e.g., UE 505-1 and/or UE 505-2) may correspond to one or more other UEs described elsewhere herein, such as UE 120. In some aspects, the one or more sidelink channels 510 may use a PC5 interface and/or may operate in a high frequency band (e.g., the 5.9 GHz band). Additionally, or alternatively, the UEs 505 may synchronize timing of transmission time intervals (TTIs) (e.g., frames, subframes, slots, or symbols) using global navigation satellite system (GNSS) timing.

As further shown in FIG. 5, the one or more sidelink channels 510 may include a PSCCH 515, a PSSCH 520, and/or a PSFCH 525. The PSCCH 515 may be used to communicate control information, similar to a PDCCH and/or a PUCCH used for cellular communications with a base station 110 via an access link or an access channel. The PSSCH 520 may be used to communicate data, similar to a PDSCH and/or a PUSCH used for cellular communications with a base station 110 via an access link or an access channel. For example, the PSCCH 515 may carry sidelink control information (SCI) 530, which may indicate various control information used for sidelink communications, such as one or more resources (e.g., time resources, frequency resources, and/or spatial resources) where a transport block (TB) 535 may be carried on the PSSCH 520. The TB 535 may include data. The PSFCH 525 may be used to communicate sidelink feedback 540, such as HARQ feedback (e.g., acknowledgement or negative acknowledgement (ACK/NACK) information), transmit power control (TPC), and/or an SR.

Although shown on the PSCCH 515, in some aspects, the SCI 530 may include multiple communications in different stages, such as a first stage SCI (SCI-1) and a second stage SCI (SCI-2). The SCI-1 may be transmitted on the PSCCH 515. The SCI-2 may be transmitted on the PSSCH 520. The SCI-1 may include, for example, an indication of one or more resources (e.g., time resources, frequency resources, and/or spatial resources) on the PSSCH 520, information for decoding sidelink communications on the PSSCH, a QoS priority value, a resource reservation period, a PSSCH DMRS pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 520, such as a HARQ process ID, a new data indicator (NDI), a source identifier, a destination identifier, and/or a CSI report trigger.

In some aspects, the one or more sidelink channels 510 may use resource pools. For example, a scheduling assignment (e.g., included in SCI 530) may be transmitted in sub-channels using specific RBs across time. In some aspects, data transmissions (e.g., on the PSSCH 520) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 505 may operate using a sidelink transmission mode (e.g., Mode 1) where resource selection and/or scheduling is performed by a base station 110 (e.g., a base station, a CU, or a DU). For example, the UE 505 may receive a grant (e.g., in DCI or in an RRC message, such as for configured grants) from the base station 110 (e.g., directly or via one or more network nodes) for sidelink channel access and/or scheduling. In some aspects, a UE 505 may operate using a transmission mode (e.g., Mode 2) where resource selection and/or scheduling is performed by the UE 505 (e.g., rather than a base station 110). In some aspects, the UE 505 may perform resource selection and/or scheduling by sensing channel availability for transmissions. For example, the UE 505 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 505 may perform resource selection and/or scheduling using SCI 530 received in the PSCCH 515, which may indicate occupied resources and/or channel parameters. Additionally, or alternatively, the UE 505 may perform resource selection and/or scheduling by determining a channel busy ratio (CBR) associated with various sidelink channels, which may be used for rate control (e.g., by indicating a maximum number of resource blocks that the UE 505 can use for a particular set of subframes).

In the transmission mode where resource selection and/or scheduling is performed by a UE 505, the UE 505 may generate sidelink grants, and may transmit the grants in SCI 530. A sidelink grant may indicate, for example, one or more parameters (e.g., transmission parameters) to be used for an upcoming sidelink transmission, such as one or more resource blocks to be used for the upcoming sidelink transmission on the PSSCH 520 (e.g., for TBs 535), one or more subframes to be used for the upcoming sidelink transmission, and/or an MCS to be used for the upcoming sidelink transmission. In some aspects, a UE 505 may generate a sidelink grant that indicates one or more parameters for semi-persistent scheduling (SPS), such as a periodicity of a sidelink transmission. Additionally, or alternatively, the UE 505 may generate a sidelink grant for event-driven scheduling, such as for an on-demand sidelink message.

In some examples, a wireless communication device, such as a programmable logic controller (PLC) or a UE (e.g., UE 120, UE 505), may control a set of UEs, such as industrial Internet of Things (IIoT) UEs or sidelink UEs (e.g., UEs 505) communicating on a sidelink. The wireless communication device may communicate with the set of UEs and with a network entity (e.g., a BS 110). In some examples, an NES state of the network entity may impact communications of the wireless communication device or the set of UEs with the network entity, such as due to a number of active antennas, RF chains, or antenna panels changing at the network entity. Some techniques described herein provide communication, between the wireless communication device and the network entity or the set of UEs and the network entity, using a transmission configuration that is based at least in part on the NES state of the network entity.

As indicated above, FIG. 5 is provided as an example. Other examples may differ from what is described with respect to FIG. 5.

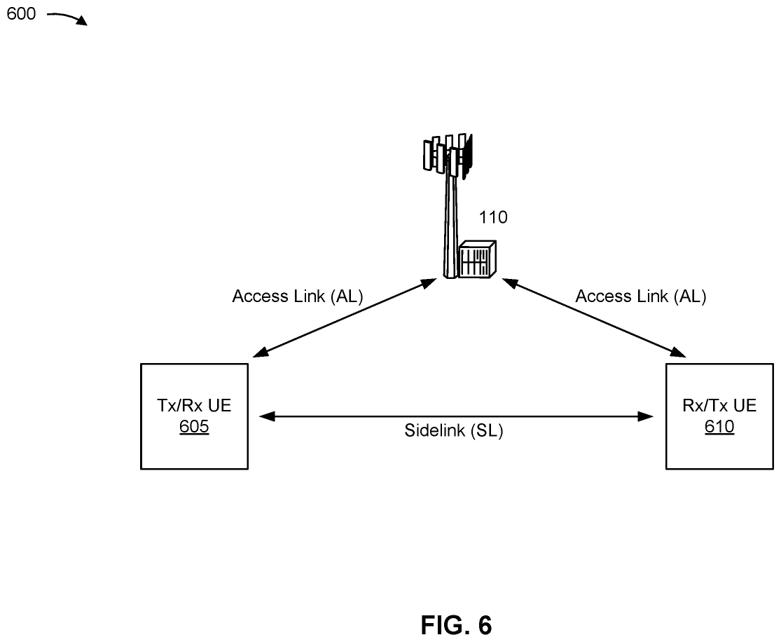

FIG. 6 is a diagram illustrating an example 600 of sidelink communications and access link communications, in accordance with the present disclosure.

As shown in FIG. 6, a transmitter (Tx)/receiver (Rx) UE 605 and an Rx/Tx UE 610 may communicate with one another via a sidelink, as described above in connection with FIG. 5. As further shown, in some sidelink modes, a base station 110 may communicate with the Tx/Rx UE 605 (e.g., directly or via one or more network entities, such as a wireless communication device), such as via a first access link. Additionally, or alternatively, in some sidelink modes, the base station 110 may communicate with the Rx/Tx UE 610 (e.g., directly or via one or more network entities such as a wireless communication device), such as via a first access link. The Tx/Rx UE 605 and/or the Rx/Tx UE 610 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 6 is provided as an example. Other examples may differ from what is described with respect to FIG. 6.

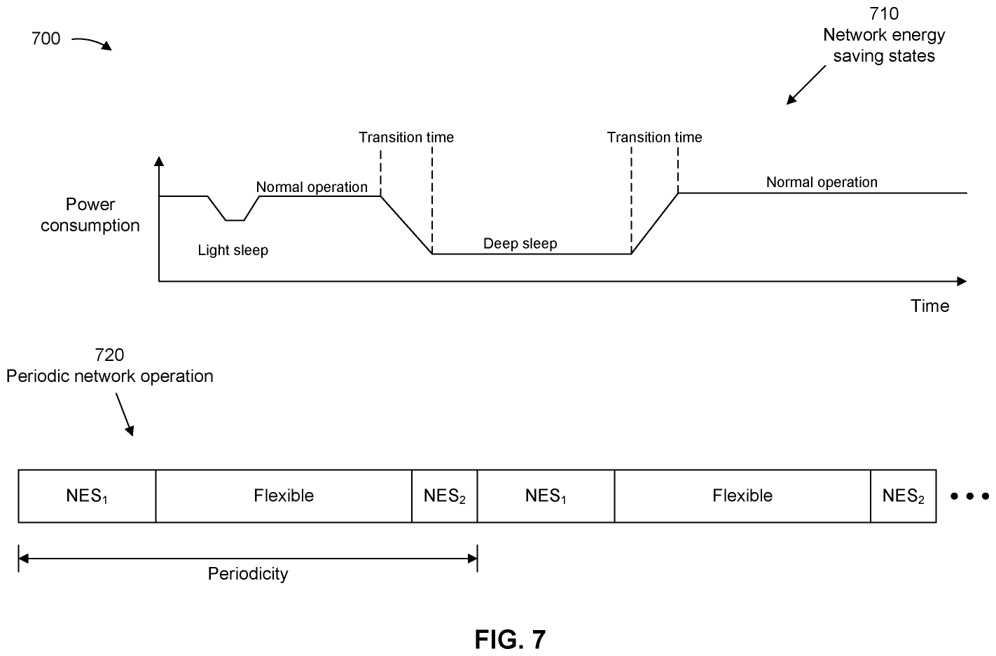

FIG. 7 is a diagram illustrating an example 700 of network operations to reduce energy consumption, in accordance with the present disclosure. Network energy saving and/or network energy efficiency measures are expected to have increased importance in wireless network operations for various reasons, including climate change mitigation, environmental sustainability, and network cost reduction. For example, although NR generally offers a significant energy efficiency improvement per gigabyte over previous generations (for example, LTE), new NR use cases that demand high data rates and/or the adoption of millimeter wave frequencies may require more network sites, greater network density, more network antennas, larger bandwidths, and/or more frequency bands, which could potentially lead to a more efficient wireless network that nonetheless has higher energy requirements and/or causes more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity). Most energy consumption and/or energy costs come from powering a RAN, which accounts for about half of the energy consumed by a wireless network. Accordingly, measures to increase network energy savings and/or network energy efficiency are important factors that may drive adoption and/or expansion of wireless networks.

One way to increase energy efficiency in a RAN may be to adapt network energy consumption models to achieve more efficient operation dynamically and/or semi-statically. For example, power consumption in a RAN can generally be split into a dynamic portion, in which power is consumed only when data transmission and/or reception is ongoing, and a static portion, in which power is consumed all of the time to maintain the operation of radio access devices even when data transmission and/or reception is not ongoing. Accordingly, one potential approach to improve network energy savings may be to adapt power consumption models from the network perspective by reducing relative energy consumption for downlink and/or uplink communication (for example, considering factors such as power amplifier (PA) efficiency, quantities of transceiver units (TxRUs), and/or network load, among other examples), enabling network sleep states and associated transition times, and/or defining appropriate reference parameters and/or configurations. For example, in some cases, different NES states may be configured to enable granular adaptation of transmission and/or reception to reduce energy consumption using techniques in time, frequency, spatial, and/or power domains, with potential support and/or feedback from UEs and/or potential UE assistance information. However, network devices and UEs may need to exchange and/or coordinate information over network interfaces to control configurations, communication parameters, and/or UE behavior for each NES state, which can increase configuration complexity and/or signaling overhead. This may pose challenges because techniques to reduce network energy consumption should generally be designed to avoid having a large impact on key performance indicators (KPIs) related to network and/or UE performance (for example, spectral efficiency, latency, UE power consumption, and/or complexity, among other examples).

Accordingly, as shown in FIG. 7, a network entity may be configured to operate in different NES states 710 over time, where each NES state 710 may use one or more techniques to adapt transmission and/or reception in time, frequency, spatial, and/or power domains. A NES state may be referred to herein as an energy state. A wireless communication device (e.g., a PLC or a transmitting UE) can also use a NES state, which may adapt transmission and/or reception of the wireless communication device in time, frequency, spatial, and/or power domains. For example, as shown in FIG. 7, the NES states 710 of the network entity may include a normal operation mode (which may also be referred to as a legacy mode or a default mode) and one or more sleep modes that may be associated with a lower power consumption than the normal operation mode. In general, a network node may transition between different NES states 710 to save power and maintain network operation (for example, minimizing impact on KPIs such as spectral efficiency, capacity, user perceived throughput (UPT), latency, UE power consumption, complexity, handover performance, call drop rate, initial access performance, and/or service level agreement assurance). Furthermore, the network node may transition between different sleep modes based on traffic demands (for example, entering a light sleep mode when traffic demands are slightly lower than usual and/or entering a deep sleep mode when traffic demands are much lower than usual), and different sleep modes may be associated with different energy saving techniques (for example, one or more antenna panels, antenna ports, and/or RF chains may be turned off in the deep sleep mode but remain on in the light sleep mode). Accordingly, as shown in FIG. 7, the normal operation mode and the different sleep modes may vary in terms of power consumption and may be associated with different transition times (for example, a transition time to or from the deep sleep mode may be longer than a transition time to or from the light sleep mode).

In some cases, as described herein, an NES state 710 may generally correspond to a particular set of configurations, communication parameters, and/or UE behaviors. For example, an NES state 710 may include a set of configurations, communication parameters, and/or UE behaviors associated with one or more energy saving techniques that are implemented in the time, frequency, spatial, and/or power domain to reduce energy consumption. For example, a network node may be configured to not transmit an SSB to reduce energy consumption in a first NES state 710 (for example, an SSB-less NES state 710), and may be configured to employ other energy saving techniques such as turning off one or more antenna panels in a second NES state 710. Furthermore, in some cases, an NES state 710 may be associated with a set of configurations, communication parameters, and/or UE behaviors associated with the normal or legacy mode of network operation. Accordingly, because one design objective in energy-efficient wireless networks is to achieve more efficient operation dynamically and/or semi-statically, a network node may configure a semi-static pattern 720 to achieve network energy savings. For example, as shown in FIG. 7, the semi-static pattern 720 (for example, configured via RRC signaling) may include a sequence of NES states 710 that the network node follows in accordance with a given periodicity (for example, in FIG. 7, the network node operates in accordance with a first NES state, shown as NES₁, for a first time period, then operates in a flexible mode for a second time period, then operates in accordance with a second NES state, shown as NES₂, for a third time period, and the pattern then repeats). In cases where the semi-static pattern 720 includes a flexible mode, the network node may operate in accordance with any suitable NES state during the time period corresponding to the flexible mode (for example, depending on current traffic conditions), and the NES state that the network node selects for the time period corresponding to the flexible mode may be dynamically indicated to served UEs.

As indicated above, FIG. 7 is provided as an example. Other examples may differ from what is described with regard to FIG. 7.

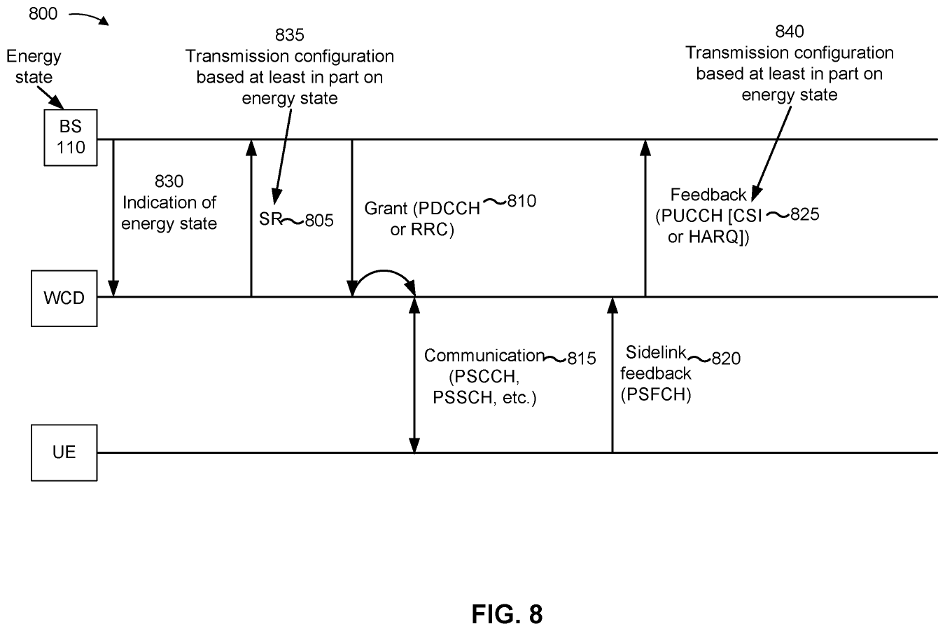

FIG. 8 is a diagram illustrating an example 800 of a network entity, a wireless communication device, and a sidelink UE, in accordance with the present disclosure. The network entity may include, for example, BS 110. The wireless communication device may include, for example, a PLC or a sidelink UE (e.g., a transmitting UE). The sidelink UE may include, for example, UE 120, UE 505, or UE 605.

As shown by reference number 805, the wireless communication device may transmit, to the network entity, an SR. As shown by reference number 810, the wireless communication device may receive a grant based at least in part on the SR. For example, the wireless communication device may receive the grant in response to the SR. In some aspects, the grant may be for a transmission to the sidelink UE, as shown by reference number 815. For example, the grant may indicate a resource for the transmission to the sidelink UE. In some aspects, the grant may indicate a resource for a BSR transmission. A BSR indicates an amount of buffered data at the wireless communication device. The network entity may provide a subsequent grant (e.g., taking into account the amount of buffered data) for a transmission of the wireless communication device. Thus, the SR can be for either a communication with a sidelink UE or for a resource on which to transmit a BSR (which may be followed by a grant for a resource for a communication with the sidelink UE). Additionally, or alternatively, the SR may indicate a resource for transmission of feedback shown by reference number 825. For example, the feedback may include feedback regarding a communication on the sidelink (where the feedback regarding the communication on the sidelink is shown by reference number 820) and/or feedback regarding reception of the grant. As shown, the grant shown by reference number 810 can be provided via a PDCCH and/or RRC signaling.

As shown by reference number 815, the wireless communication device may transmit a communication (e.g., a sidelink transmission) to the sidelink UE. The wireless communication device may transmit the communication via a PSCCH and/or a PSSCH (such as SCI scheduling the communication via the PSCCH and PSSCH, and the communication itself via the PSSCH). In some aspects, the communication shown by reference number 815 may include a reference signal, such as a CSI-RS for the determination of CSI feedback by the sidelink UE. As shown by reference number 820, the sidelink UE may provide sidelink feedback (such as a HARQ acknowledgment (ACK) or negative ACK (NACK)) to the wireless communication device. In some aspects, the sidelink UE may provide CSI feedback regarding the sidelink to the wireless communication device. Additionally, or alternatively, the wireless communication device may determine sidelink feedback (e.g., CSI feedback regarding the sidelink) using a transmission of the sidelink UE.

As shown by reference number 825, the wireless communication device may transmit feedback to the network entity. The wireless communication device may transmit the feedback via a PUCCH. The feedback may include, for example, CSI feedback (determined by the wireless communication device or the sidelink UE), HARQ feedback (determined by the wireless communication device or the sidelink UE), or another form of feedback.

Thus, in Mode 1 resource allocation on the sidelink (e.g., in which the network entity allocates resources for sidelink transmissions), such as using a dynamic grant or a configured grant, a UE (e.g., the wireless communication device or the sidelink UE) may transmit HARQ feedback, CSI feedback, or an SR (which may be followed by a BSR) to the network entity. For example, the wireless communication device may transmit an SR, HARQ feedback regarding a sidelink communication or the reception of the grant for a Mode 1 resource allocation, or CSI feedback regarding the sidelink.

The NES state of a network entity (e.g., BS 110) may affect the reception of communications at the network entity. For example, the network entity may change NES states according to traffic conditions or other conditions associated with the network entity. In some examples, a NES state may lead to reduced reception performance (e.g., as characterized by an SINR) due to reduced beamforming gain that results from a reduced number of active receive antennas. As another example, a network entity in a particular NES state may not process feedback received in the particular NES state, or may have a reduced reception capability (for example, due to using a decreased number of RF chains or receive antennas), which may lead to a reduction in the number of UEs from which the network entity can effectively and/or concurrently receive feedback or SRs. If transmission of feedback and/or SRs from a wireless communication device or a sidelink UE is performed without concern for the energy state of the network entity, then SRs or feedback may be dropped, leading to diminished throughput, suboptimal utilization of the channel, and increased overhead.

Some techniques described herein provide transmission of feedback (e.g., HARQ feedback or CSI feedback), or an SR, to a network entity based at least in part on an energy state (e.g., a NES state) of the network entity. For example, the network entity may provide an indication of the energy state of the network entity, as shown by reference number 830. As shown by reference number 835, in some aspects, the SR may use a transmission configuration based at least in part on the energy state. As shown by reference number 840, in some aspects, the feedback may use a transmission configuration based at least in part on the energy state. Examples of the impact of the transmission configuration on then SR or the feedback are provided below.

In this way, the transmission of the SR or feedback may take into account the energy state (e.g., NES state) of the network entity, which reduces the occurrence of dropped or missed feedback or SRs, thereby increasing throughput, improving utilization of the channel, and reducing overhead.

As mentioned above, at reference number 830, the wireless communication device may receive an indication of an energy state of the network entity. For example, the network entity may provide a semi-static pattern (e.g., semi-static pattern 720) indicating the energy state (e.g., NES state 710) of the network entity at a given time. As another example, the network entity may provide a dynamic indication of the energy state of the network entity. If the energy state of the network entity changes, the network entity may provide an indication of the change of the energy state. Alternatively, the semi-static pattern may indicate a time at which the energy state of the network entity changes, such that the wireless communication device can identify that the energy state has changed. In some aspects, the wireless communication device may defer transmission of the feedback shown by reference number 825 until a change of the energy state (for example, a change from an energy state having fewer active antennas to an energy state having more active antennas). In this example, the network entity may provide, prior to transmission of the feedback, an indication to defer transmission of the feedback until a change in the energy state of the network entity. The wireless communication device may transmit the feedback shown by reference number 825 based at least in part on the indication. For example, the wireless communication device may transmit the feedback shown by reference number 825 upon a change of the energy state of the network entity (as determined by reference to the semi-static pattern or an indication of the change received from the network entity). The indication to defer transmission of the feedback can be via Layer 1 signaling (e.g., DCI), Layer 2 signaling (e.g., MAC signaling), Layer 3 signaling (e.g., RRC signaling), or the like. In some aspects, the transmission configuration may indicate to defer transmission of feedback until the change in the energy state of the network entity. For example, the transmission configuration may indicate that the feedback is not to be transmitted during a first energy state and/or until the network entity has changed to a second energy state. Thus, signaling overhead is reduced relative to explicit signaling of the indication.

As mentioned, in some aspects, the wireless communication device may transmit the SR in accordance with the transmission configuration. For example, the transmission configuration may include an SR configuration. The SR configuration may indicate, for example, a resource for transmission of the SR, a periodicity of the resource, a priority for the SR, a PUCCH identifier of a PUCCH to carry the SR, a mapping between a PUCCH identifier and an energy state of the network entity, or one or more configuration parameters for a PUCCH identifier of a PUCCH to carry the SR. In some aspects, the SR configuration may indicate an SR set to be activated in association with an energy state. For example, the wireless communication device may be configured with multiple SR sets, and an SR set of the multiple SR sets may be mapped to the energy state. The wireless communication device may activate the SR set that is mapped to the energy state, and may transmit an SR on a resource indicated by the SR set and/or using a configuration of the SR set.

As mentioned, in some aspects, the wireless communication device may transmit the feedback in accordance with the transmission configuration. For example, the feedback may include HARQ feedback regarding a communication on the sidelink. In some aspects, the wireless communication device may receive the communication and generate the HARQ feedback. In some other aspects, the wireless communication device may receive the HARQ feedback from the sidelink UE. The transmission configuration may indicate one or more parameters for transmission of the HARQ feedback. For example, the transmission configuration may indicate a timeline from receiving the HARQ feedback from the sidelink UE and transmitting the feedback to the network entity via a PUCCH. As another example, the transmission configuration may indicate a repetition configuration for the PUCCH (such as a number of repetitions, a periodicity of repetition, whether or not to perform repetition or the like). As another example, the transmission configuration may indicate a resource size for the PUCCH (e.g., for a same PUCCH identifier). As yet another example, the transmission configuration may indicate to skip (e.g., drop, cancel, defer) transmission of the feedback, for example, altogether or until the network entity is in a different energy state. Thus, the transmission of the feedback is adapted to the energy state of the network entity, such as to reduce the transmission or repetition of PUCCHs while the network entity has a reduced number of active receive antennas or RF chains.

In some aspects, the feedback may include CSI feedback, such as CSI feedback determined by the wireless communication device or CSI feedback determined by the sidelink UE and provided to the wireless communication device. For example, the CSI feedback may include a CSI report or one or more parameters of a CSI report. In some aspects, the CSI feedback may include bundled CSI feedback, such as multiple instances of CSI feedback (which may be generated by the wireless communication device, the sidelink UE, multiple sidelink UEs, or a combination thereof).

In some aspects, CSI feedback may be associated with a CSI identifier. For example, CSI feedback may be grouped (e.g., according to a priority of the CSI feedback, an identity of the device that generates the CSI feedback, a configuration of a CSI resource, or the like). A group of CSI feedback may be associated with a CSI identifier. Additionally, or alternatively, each instance of CSI feedback may be associated with a CSI identifier. The transmission configuration may indicate a reporting time for CSI feedback based at least in part on a CSI identifier of the CSI feedback. For example, the network entity may provide (via Layer 1, Layer 2, and/or Layer 3 signaling) an indication of a reporting time for a particular CSI identifier or a particular group of CSI identifiers. The wireless communication device may transmit CSI feedback corresponding to the particular CSI identifier or the particular group of CSI identifiers in accordance with the indication (i.e., the transmission configuration). For example, the network entity may transmit CSI feedback corresponding to a particular CSI identifier or group of CSI identifiers based at least in part on the transmission configuration indicating to transmit the CSI feedback corresponding to the particular CSI identifier or group of CSI identifiers when the network entity is in an energy state, and based at least in part on the network entity being in the energy state.

In some aspects, the CSI feedback may be associated with an expiration timer. For example, a particular CSI identifier may be associated with an expiration timer. As another example, each instance of CSI feedback may be associated with a respective expiration timer. If the expiration timer for CSI feedback expires, the wireless communication device may drop (e.g., not transmit) the CSI feedback. The wireless communication device may transmit CSI feedback based at least in part on the expiration timer associated with the CSI feedback not having expired. For example, the wireless communication device may transmit the CSI feedback if the expiration timer has not expired, and may drop the CSI feedback if the expiration timer has expired.

In some aspects, the HARQ feedback may be associated with an expiration timer. For example, a particular HARQ identifier (e.g., a HARQ process identifier, an identifier of traffic corresponding to HARQ feedback) may be associated with an expiration timer. As another example, each instance of HARQ feedback may be associated with a respective expiration timer. If the expiration timer for HARQ feedback expires, the wireless communication device may drop (e.g., not transmit) the HARQ feedback. The wireless communication device may transmit HARQ feedback based at least in part on the expiration timer associated with the HARQ feedback not having expired. For example, the wireless communication device may transmit the HARQ feedback if the expiration timer has not expired, and may drop the HARQ feedback if the expiration timer has expired. In some aspects, the expiration timer may be based at least in part on a packet delay budget (PDB), which indicates a remaining amount of delay that can be incurred for a packet. For example, the expiration timer for HARQ feedback, corresponding to a particular packet, may be equal in length to a remaining PDB of the particular packet. Thus, stale HARQ feedback can be dropped after expiration of the timer, which enables buffering of HARQ feedback, for example, during an energy state of the network entity in which the transmission configuration indicates not to transmit the HARQ feedback.

In some aspects, the wireless communication device may receive a trigger to transmit accumulated feedback. For example, the wireless communication device may buffer feedback (e.g., HARQ feedback, CSI feedback, or a combination thereof) while the transmission configuration indicates not to transmit the feedback (e.g., while the network entity is in a particular energy state, the wireless communication device is in a particular energy state, or the network entity and the wireless communication device are in a particular joint energy state). Buffered feedback may be referred to as accumulated feedback. The network entity may provide a trigger for the wireless communication device to transmit accumulated feedback, such as a trigger to transmit all accumulated feedback or a trigger to transmit a subset of accumulated feedback (e.g., feedback associated with a particular identifier). The wireless communication device may transmit the accumulated feedback (e.g., in a one-shot codebook transmission, in which accumulated feedback is provided in a single transmission). In some aspects, the network entity may enable and/or configure accumulation of feedback (e.g., the network entity may provide a transmission configuration indicating to enable and/or configure accumulation of feedback) via Layer 1, Layer 2, and/or Layer 3 signaling. The accumulation and transmission of feedback can be enabled, configured, and/or performed for HARQ feedback, CSI feedback, or a combination thereof. Thus, the wireless communication device may enable one-shot feedback for sidelink bits and/or for bundled CSI (e.g., a CSI identifier and one or more CSI bits).

In some aspects, the feedback may include CSI feedback determined using a CSI-RS. In this scenario, a CSI identifier may be an identifier that is configured between the wireless communication device and the sidelink UE. In some aspects, the CSI identifier may include a HARQ identifier of data that will be scheduled with a CSI-RS corresponding to the feedback. In some aspects, the CSI identifier may include an associated identifier that is configured, by the network entity, for the wireless communication device or the sidelink UE to use. In some aspects, the CSI identifier may include a logical channel identifier (LCID) or a logical channel group identifier (LCGID) associated with data scheduled with the CSI-RS. In some aspects, the CSI identifier may include a CSI process identifier. In some aspects, the CSI identifier may include an identifier associated with a source identifier and a destination identifier of the CSI-RS. In some aspects, the CSI identifier may include a source identifier and a destination identifier of data with which the CSI-RS is multiplexed. In some aspects, the CSI identifier may include a CSI report configuration identifier.

In some aspects, the feedback may include CSI feedback determined using a PSSCH. In this scenario, the CSI identifier may be an identifier that is configured between the wireless communication device and the sidelink UE. In some aspects, the CSI identifier may include a HARQ identifier of data on the PSSCH. In some aspects, the CSI identifier may include an associated identifier that is configured, by the network entity, for the wireless communication device or the sidelink UE to use. In some aspects, the CSI identifier may include a LCID or a LCGID associated with data scheduled on the PSSCH. In some aspects, the CSI identifier may include a CSI process identifier. In some aspects, the CSI identifier may include an identifier associated with a source identifier and a destination identifier of the PSSCH. In some aspects, the CSI identifier may include a CSI report configuration identifier.

In some aspects, the transmission configuration may be based at least in part on an energy state of the wireless communication device. For example, the wireless communication device may include a PLC that is capable of using multiple different energy states. The transmission configuration may be based at least in part on a joint energy state of the wireless communication device and the network entity (e.g., an energy state of the wireless communication device and an energy state of the network entity). For example, the transmission configuration may indicate a time between feedback occasions for transmissions of the feedback (e.g., transmission of a bundled set of HARQ feedback and/or a bundled set of CSI feedback) may be based at least in part on the joint energy state (such that, for example, a longer time between feedback occasions is provided for a joint energy state associated with fewer active antennas than for a joint energy state associated with more active antennas). As another example, a time between SR occasions (e.g., resources for transmission of SRs), indicated by the transmission configuration, may be based at least in part on the joint energy state or the energy state of the wireless communication device. Thus, an SR periodicity or time between two occasions may be a function of an energy state of the wireless communication device and/or the joint energy state.

In some aspects, the feedback may have a minimum timeline. For example, the minimum timeline may indicate a minimum length of time between reception of a channel and transmission of feedback regarding the channel (e.g., via a parameter minPSSCHtoPSFCH for HARQ feedback or another parameter for CSI feedback). The feedback can include HARQ feedback or CSI feedback. In some aspects, the transmission configuration may indicate the minimum timeline. For example, the transmission configuration may indicate that the minimum timeline is lengthened (e.g., delayed, relaxed) during a particular energy state of the wireless communication device and/or the network entity (e.g., a joint energy state, an energy state of the wireless communication device, and/or an energy state of the network entity). Thus, processing complexity at the wireless communication device or the sidelink UE is reduced since processing of feedback can be delayed while feedback is buffered during a particular energy state.

In some aspects, the feedback may indicate a HARQ identifier of deferred feedback. For example, the network entity may transmit a request for the wireless communication device to transmit feedback and a HARQ identifier for each signal for which the feedback is deferred.

In some aspects, at least one of the SR, the HARQ feedback, or the CSI feedback may be disabled. For example, the transmission configuration may indicate that at least one of the SR, the HARQ feedback, or the CSI is disabled for a particular energy state of the wireless communication device, an energy state of the network entity, or a joint energy state. Thus, overhead is reduced relative to transmitting the SR, the HARQ feedback, or the CSI feedback while the network entity or the wireless communication device is in an energy state that precludes reception or transmission of the SR, the HARQ feedback, or the CSI feedback.

In some aspects, the network entity may configure a resource allocation (e.g., a PUSCH resource allocation or a PUCCH resource allocation). For example, the network entity may configure the resource allocation for dynamic BSR transmission. In this example, the wireless communication device may transmit the BSR without having transmitted an SR to obtain the resource allocation, thereby enabling the disablement of the SR in certain energy states.

As indicated above, FIG. 8 is provided as an example. Other examples may differ from what is described with regard to FIG. 8.

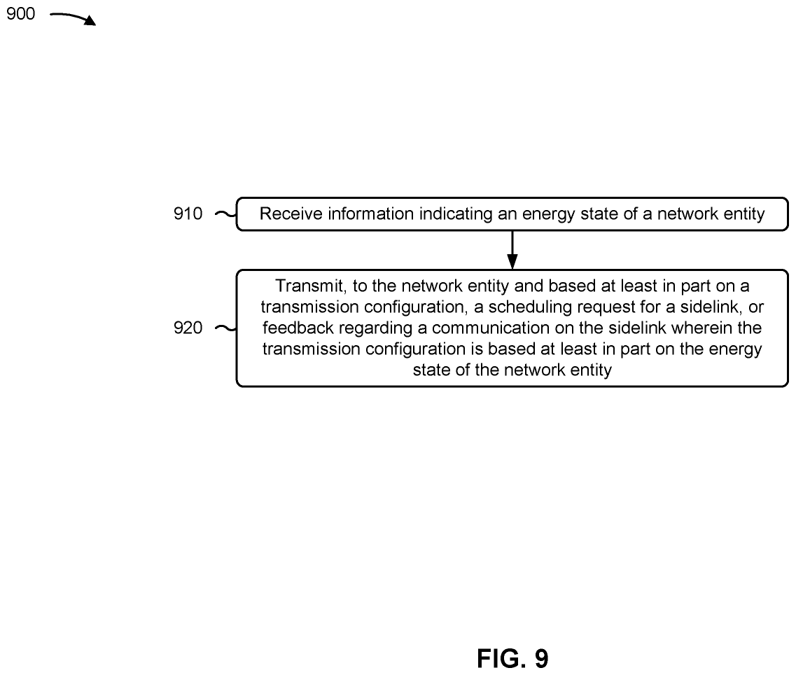

FIG. 9 shows a method 900 for wireless communications by a wireless communication device, such as UE 120 or a PLC.

Method 900 begins at step 910 with receiving information indicating an energy state of a network entity.

Method 900 then proceeds to step 920 with transmitting, to the network entity and based at least in part on a transmission configuration, a scheduling request for a sidelink, or feedback regarding a communication on the sidelink, wherein the transmission configuration is based at least in part on the energy state of the network entity.

In a first aspect, the transmission configuration comprises a scheduling request configuration.

In a second aspect, alone or in combination with the first aspect, method 900 includes receiving a grant for a resource in response to the scheduling request, and performing a sidelink transmission on the resource.

In a third aspect, alone or in combination with one or more of the first and second aspects, method 900 includes receiving a grant for a resource in response to the scheduling request, and transmitting a buffer status report on the resource.

In a fourth aspect, alone or in combination with one or more of the first through third aspects, the transmission configuration comprises a configuration of a physical uplink control channel and transmitting the feedback further comprises transmitting the feedback via the physical uplink control channel.

In a fifth aspect, alone or in combination with one or more of the first through fourth aspects, the feedback comprises channel state information feedback and the method further comprises receiving an indication of a channel state information identifier corresponding to the channel state information feedback, wherein the feedback is transmitted in accordance with the channel state information identifier.

In a sixth aspect, alone or in combination with one or more of the first through fifth aspects, transmitting the feedback further comprises transmitting the channel state information feedback based at least in part on an expiration timer associated with the channel state information feedback having not expired.

In a seventh aspect, alone or in combination with one or more of the first through sixth aspects, the feedback comprises hybrid automatic repeat request feedback and transmitting the feedback further comprises transmitting the hybrid automatic repeat request feedback based at least in part on an expiration timer associated with the hybrid automatic repeat request feedback having not expired, wherein the expiration timer is based at least in part on a packet delay budget.

In an eighth aspect, alone or in combination with one or more of the first through seventh aspects, method 900 includes receiving a trigger to transmit accumulated feedback including the feedback, wherein transmitting the feedback is in response to the trigger.

In a ninth aspect, alone or in combination with one or more of the first through eighth aspects, the feedback comprises hybrid automatic repeat request feedback or channel state information feedback.

In a tenth aspect, alone or in combination with one or more of the first through ninth aspects, the transmission configuration is further based at least in part on an energy state of the wireless communication device.

In an eleventh aspect, alone or in combination with one or more of the first through tenth aspects, a time between feedback occasions, indicated by the transmission configuration, is based at least in part on the energy state of the wireless communication device and the energy state of the network entity.

In a twelfth aspect, alone or in combination with one or more of the first through eleventh aspects, a time between scheduling request occasions, indicated by the transmission configuration, is based at least in part on the energy state of the wireless communication device and the energy state of the network entity.

In a thirteenth aspect, alone or in combination with one or more of the first through twelfth aspects, the transmission configuration indicates that a minimum timeline for the feedback is extended based at least in part on the energy state and relative to another minimum timeline for another energy state, and wherein transmitting the feedback further comprises transmitting the feedback in accordance with the minimum timeline.

In a fourteenth aspect, alone or in combination with one or more of the first through thirteenth aspects, method 900 includes receiving, prior to transmitting the feedback, an indication to defer transmission of the feedback until a change in the energy state of the network entity, wherein transmitting the feedback is based at least in part on the indication.

In a fifteenth aspect, alone or in combination with one or more of the first through fourteenth aspects, transmitting the feedback is based at least in part on the change in the energy state of the network entity.

In a sixteenth aspect, alone or in combination with one or more of the first through fifteenth aspects, method 900 includes receiving an indication to transmit deferred feedback, wherein the indication to transmit the deferred feedback indicates an identifier associated with the deferred feedback.

In a seventeenth aspect, alone or in combination with one or more of the first through sixteenth aspects, method 900 includes transmitting a buffer status report on the resource without having transmitted the scheduling request in association with the buffer status report.

In an eighteenth aspect, alone or in combination with one or more of the first through seventeenth aspects, the energy state of the network entity indicates a number of antennas, a number of radio frequency chains, or a number of antenna panels active in association with the network entity.

In a nineteenth aspect, alone or in combination with one or more of the first through eighteenth aspects, method 900 includes receiving the communication prior to transmitting the feedback, wherein the feedback is based at least in part on the communication.

In a twentieth aspect, alone or in combination with one or more of the first through nineteenth aspects, method 900 includes receiving the feedback from a user equipment, wherein the communication is by the user equipment.

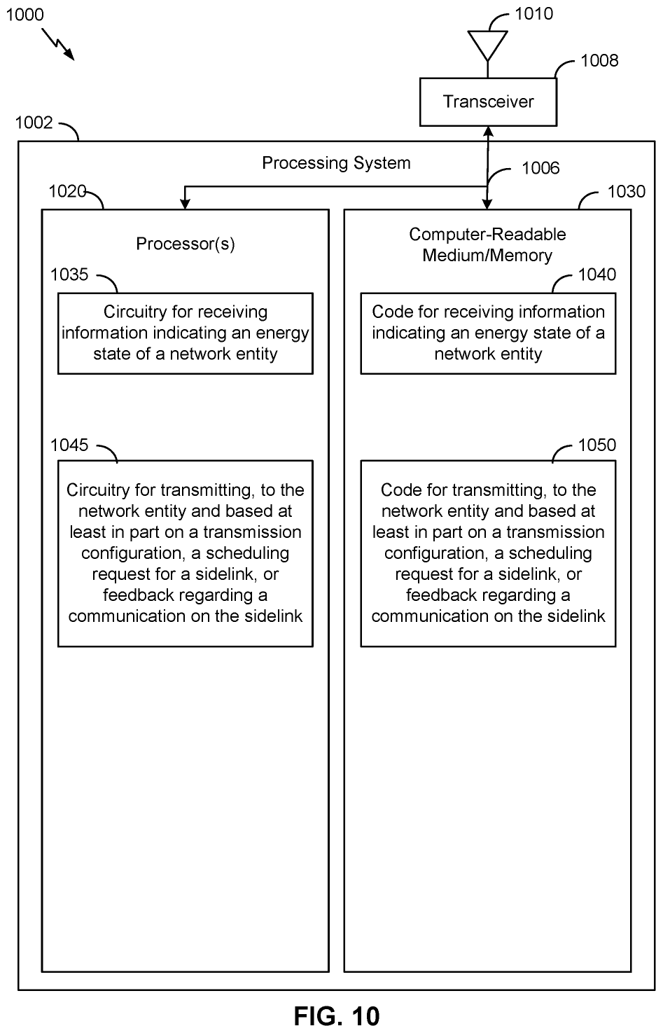

In one aspect, method 900, or any aspect related to it, may be performed by an apparatus, such as communications device 1000 of FIG. 10, which includes various components operable, configured, or adapted to perform the method 900. Communications device 1000 is described below in further detail.

Note that FIG. 9 is just one example of a method, and other methods including fewer, additional, or alternative steps are possible consistent with this disclosure.

FIG. 10 is a diagram illustrating an example of an implementation of code and circuitry for a communications device 1000, in accordance with the present disclosure. The communications device 1000 may be a wireless communication device, or a wireless communication device may include the communications device 1000.

The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes one or more processors 1020. In various aspects, the one or more processors 1020 may be representative of one or more of receive processor 258, transmit processor 264, TX MIMO processor 266, and/or controller/processor 280, as described with respect to FIG. 2. The one or more processors 1020 are coupled to a computer-readable medium/memory 1030 via a bus 1006. In various aspects, the computer-readable medium/memory 1030 may be representative of memory 282, as described with respect to FIG. 2. In certain aspects, the computer-readable medium/memory 1030 is configured to store instructions (e.g., computer-executable code, processor-executable code) that when executed by the one or more processors 1020, cause the one or more processors 1020 to perform the method 900 described with respect to FIG. 9, or any aspect related to it. Note that reference to a processor performing a function of communications device 1000 may include one or more processors performing that function of communications device 1000.

As shown in FIG. 10, the communications device 1000 may include circuitry for receiving information indicating an energy state of a network entity (circuitry 1035).

As shown in FIG. 10, the communications device 1000 may include, stored in computer-readable medium/memory 1030, code for receiving information indicating an energy state of a network entity (code 1040).

As shown in FIG. 10, the communications device 1000 may include circuitry for transmitting, to the network entity and based at least in part on a transmission configuration, a scheduling request for a sidelink, or feedback regarding a communication on the sidelink (circuitry 1045).

As shown in FIG. 10, the communications device 1000 may include, stored in computer-readable medium/memory 1030, code for transmitting, to the network entity and based at least in part on a transmission configuration, a scheduling request for a sidelink, or feedback regarding a communication on the sidelink (code 1050).

Various components of the communications device 1000 may provide means for performing the method 900 described with respect to FIG. 9, or any aspect related to it. For example, means for transmitting, sending, or outputting for transmission may include the transceiver(s) 254 and/or antenna(s) 252 of the UE 120 and/or transceiver 1008 and antenna 1010 of the communications device 1000 in FIG. 10. Means for receiving or obtaining may include the transceiver(s) 254 and/or antenna(s) 252 of the UE 120 and/or transceiver 1008 and antenna 1010 of the communications device 1000 in FIG. 10.

FIG. 10 is provided as an example. Other examples may differ from what is described in connection with FIG. 10.

The following provides an overview of some Aspects of the present disclosure:

Aspect 1: A method of wireless communication performed by a wireless communication device, comprising: receiving information indicating an energy state of a network entity; and transmitting, to the network entity and based at least in part on a transmission configuration, a scheduling request for a sidelink, or feedback regarding a communication on the sidelink, wherein the transmission configuration is based at least in part on the energy state of the network entity.

Aspect 2: The method of Aspect 1, wherein the transmission configuration comprises a scheduling request configuration.

Aspect 3: The method of Aspect 2, further comprising: receiving a grant for a resource in response to the scheduling request; and performing a sidelink transmission on the resource.

Aspect 4: The method of Aspect 2, further comprising: receiving a grant for a resource in response to the scheduling request; and transmitting a buffer status report on the resource.

Aspect 5: The method of any of Aspects 1-4, wherein the transmission configuration comprises a configuration of a physical uplink control channel and transmitting the feedback further comprises transmitting the feedback via the physical uplink control channel.

Aspect 6: The method of any of Aspects 1-5, wherein the feedback comprises channel state information feedback and the method further comprises receiving an indication of a channel state information identifier corresponding to the channel state information feedback, wherein the feedback is transmitted in accordance with the channel state information identifier.

Aspect 7: The method of Aspect 6, wherein transmitting the feedback further comprises transmitting the channel state information feedback based at least in part on an expiration timer associated with the channel state information feedback having not expired.

Aspect 8: The method of any of Aspects 1-7, wherein the feedback comprises hybrid automatic repeat request feedback and transmitting the feedback further comprises transmitting the hybrid automatic repeat request feedback based at least in part on an expiration timer associated with the hybrid automatic repeat request feedback having not expired, wherein the expiration timer is based at least in part on a packet delay budget.

Aspect 9: The method of any of Aspects 1-8, further comprising receiving a trigger to transmit accumulated feedback including the feedback, wherein transmitting the feedback is in response to the trigger.

Aspect 10: The method of Aspect 9, wherein the feedback comprises hybrid automatic repeat request feedback or channel state information feedback.

Aspect 11: The method of any of Aspects 1-10, wherein the transmission configuration is further based at least in part on an energy state of the wireless communication device.

Aspect 12: The method of Aspect 11, wherein a time between feedback occasions, indicated by the transmission configuration, is based at least in part on the energy state of the wireless communication device and the energy state of the network entity.

Aspect 13: The method of Aspect 11, wherein a time between scheduling request occasions, indicated by the transmission configuration, is based at least in part on the energy state of the wireless communication device and the energy state of the network entity.

Aspect 14: The method of any of Aspects 1-13, wherein the transmission configuration indicates that a minimum timeline for the feedback is extended based at least in part on the energy state and relative to another minimum timeline for another energy state, and wherein transmitting the feedback further comprises transmitting the feedback in accordance with the minimum timeline.

Aspect 15: The method of any of Aspects 1-14, further comprising receiving, prior to transmitting the feedback, an indication to defer transmission of the feedback until a change in the energy state of the network entity, wherein transmitting the feedback is based at least in part on the indication.

Aspect 16: The method of Aspect 15, wherein transmitting the feedback is based at least in part on the change in the energy state of the network entity.

Aspect 17: The method of Aspect 15, further comprising receiving an indication to transmit deferred feedback, wherein the indication to transmit the deferred feedback indicates an identifier associated with the deferred feedback.

Aspect 18: The method of any of Aspects 1-17, further comprising receiving an allocation of a resource for transmission of the feedback, wherein transmitting the feedback further comprises transmitting a buffer status report on the resource without having transmitted the scheduling request in association with the buffer status report.

Aspect 19: The method of any of Aspects 1-18, wherein the energy state of the network entity indicates a number of antennas, a number of radio frequency chains, or a number of antenna panels active in association with the network entity.

Aspect 20: The method of any of Aspects 1-19, further comprising receiving the communication prior to transmitting the feedback, wherein the feedback is based at least in part on the communication.

Aspect 21: The method of any of Aspects 1-20, further comprising receiving the feedback from a user equipment, wherein the communication is by the user equipment.

Aspect 22: An apparatus for wireless communication at a device, comprising a processor; memory coupled with the processor; and instructions stored in the memory and executable by the processor to cause the apparatus to perform the method of one or more of Aspects 1-21.

Aspect 23: A device for wireless communication, comprising a memory and one or more processors coupled to the memory, the one or more processors configured to perform the method of one or more of Aspects 1-21.

Aspect 24: An apparatus for wireless communication, comprising at least one means for performing the method of one or more of Aspects 1-21.

Aspect 25: A non-transitory computer-readable medium storing code for wireless communication, the code comprising instructions executable by a processor to perform the method of one or more of Aspects 1-21.

Aspect 26: A non-transitory computer-readable medium storing a set of instructions for wireless communication, the set of instructions comprising one or more instructions that, when executed by one or more processors of a device, cause the device to perform the method of one or more of Aspects 1-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication performed by a wireless communication device, comprising:
receiving information indicating an energy state of a network entity; and
transmitting, to the network entity and based at least in part on a transmission configuration, a scheduling request for a sidelink, or feedback regarding a communication on the sidelink,
wherein the transmission configuration is based at least in part on the energy state of the network entity.

2. The method of claim 1, wherein the transmission configuration comprises a scheduling request configuration.

3. The method of claim 2, further comprising:
receiving a grant for a resource in response to the scheduling request; and
performing a sidelink transmission on the resource.

4. The method of claim 2, further comprising:
receiving a grant for a resource in response to the scheduling request; and
transmitting a buffer status report on the resource.

5. The method of claim 1, wherein the transmission configuration comprises a configuration of a physical uplink control channel and transmitting the feedback further comprises transmitting the feedback via the physical uplink control channel.

6. The method of claim 1, wherein the feedback comprises channel state information feedback and the method further comprises receiving an indication of a channel state information identifier corresponding to the channel state information feedback, wherein the feedback is transmitted in accordance with the channel state information identifier.

7. The method of claim 6, wherein transmitting the feedback further comprises transmitting the channel state information feedback based at least in part on an expiration timer associated with the channel state information feedback having not expired.

8. The method of claim 1, wherein the feedback comprises hybrid automatic repeat request feedback and transmitting the feedback further comprises transmitting the hybrid automatic repeat request feedback based at least in part on an expiration timer associated with the hybrid automatic repeat request feedback having not expired, wherein the expiration timer is based at least in part on a packet delay budget.

9. The method of claim 1, further comprising receiving a trigger to transmit accumulated feedback including the feedback, wherein transmitting the feedback is in response to the trigger.

10. The method of claim 9, wherein the feedback comprises hybrid automatic repeat request feedback or channel state information feedback.

11. The method of claim 1, wherein the transmission configuration is further based at least in part on an energy state of the wireless communication device.

12. The method of claim 11, wherein a time between feedback occasions, indicated by the transmission configuration, is based at least in part on the energy state of the wireless communication device and the energy state of the network entity.

13. The method of claim 11, wherein a time between scheduling request occasions, indicated by the transmission configuration, is based at least in part on the energy state of the wireless communication device and the energy state of the network entity.

14. The method of claim 1, wherein the transmission configuration indicates that a minimum timeline for the feedback is extended based at least in part on the energy state and relative to another minimum timeline for another energy state, and wherein transmitting the feedback further comprises transmitting the feedback in accordance with the minimum timeline.

15. The method of claim 1, further comprising receiving, prior to transmitting the feedback, an indication to defer transmission of the feedback until a change in the energy state of the network entity, wherein transmitting the feedback is based at least in part on the indication.

16. The method of claim 15, wherein transmitting the feedback is based at least in part on the change in the energy state of the network entity.

17. The method of claim 15, further comprising receiving an indication to transmit deferred feedback, wherein the indication to transmit the deferred feedback indicates an identifier associated with the deferred feedback.

18. The method of claim 1, further comprising receiving an allocation of a resource for transmission of the feedback, wherein transmitting the feedback further comprises transmitting a buffer status report on the resource without having transmitted the scheduling request in association with the buffer status report.

19. The method of claim 1, wherein the energy state of the network entity indicates a number of antennas, a number of radio frequency chains, or a number of antenna panels active in association with the network entity.

20. The method of claim 1, further comprising receiving the communication prior to transmitting the feedback, wherein the feedback is based at least in part on the communication.

21. The method of claim 1, further comprising receiving the feedback from a user equipment, wherein the communication is by the user equipment.

22. A wireless communication device for wireless communication, comprising:
a memory; and
one or more processors, coupled to the memory, configured to:
receive information indicating an energy state of a network entity; and
transmit, to the network entity and based at least in part on a transmission configuration, a scheduling request for a sidelink, or feedback regarding a communication on the sidelink,
wherein the transmission configuration is based at least in part on the energy state of the network entity.

23. A non-transitory computer-readable medium storing a set of instructions for wireless communication, the set of instructions comprising:
one or more instructions that, when executed by one or more processors of a wireless communication device, cause the wireless communication device to:
receive information indicating an energy state of a network entity; and
transmit, to the network entity and based at least in part on a transmission configuration, a scheduling request for a sidelink, or feedback regarding a communication on the sidelink,
wherein the transmission configuration is based at least in part on the energy state of the network entity.

24. An apparatus for wireless communication, comprising:
means for receiving information indicating an energy state of a network entity; and
means for transmitting, to the network entity and based at least in part on a transmission configuration, a scheduling request for a sidelink, or feedback regarding a communication on the sidelink,
wherein the transmission configuration is based at least in part on the energy state of the network entity.
